(19) United States
(12) Patent Application Publication
(10) Pub. No.: US 2005/0289613 A1
(43) Pub. Date: Dec. 29, 2005

(54) Control architecture for audio/video (A/V) systems

(75) Inventor: Micah T. Lawrence, Largo, FL (US)

Correspondence Address: Honeywell International Inc., Law Dept. AB2, 101 Columbia Road, Morristown, NJ, 07962, US

(73) Assignee: Honeywell International Inc.

(21) Appl. No.: 10/871,484

(22) Filed: Jun. 18, 2004

(51) Int. Cl. H04N 7/18; H04N 7/173

(52) U.S. Cl. 725/80; 725/100

(57) ABSTRACT

A network based home audio/video control systems. In one embodiment, the system includes, a plurality of audio/video (A/V) devices, an A/V interface panel in communication with the plurality of A/V devices, a switching matrix and an access device. The switching matrix is adapted to selectively control connections between the plurality of A/V devices through the audio/video interface panel. The access device is adapted to receive directions and produce control signals based on the received directions. Moreover, the access device is in communication with the switching matrix to control the switching matrix.

### TECHNICAL FIELD

The present invention relates generally to the field of audio/video (A/V) systems and, in particular, to network based audio/video control systems.

### BACKGROUND INFORMATION

Typically, in a home or other type of building, the ability to control music or video is restricted to the particular room where A/V systems (e.g., stereo receiver, CD player, VCR, DVD player etc.,) are located. A/V systems are controlled either manually or with a remote control device. The remote control device generally uses infra red signals for remote control which requires line of sight connection with the A/V system for proper operation. Hence the remote controls for A/V systems will not function adequately in another room. It is desirable to have the ability to listen to music or watch video from A/V systems throughout rooms of a building without having duplicate A/V devices in every room of the building However, installing multiple A/V devices significantly increases the expense to provide this additional capability.

A/V system designs have been developed to limit the number of duplicate A/V devices in a building. These designs generally rely on proprietary hardware located in each room that controls the A/V devices. Proprietary hardware typically provides an interface such as a keypad or user interface on the wall. The user interface is used to turn on or off the audio or video feed from the A/V system in one room to another room. In addition the homeowner can use the keypad to perform other functions such as increasing volume, changing channels etc. This design of an A/V system is static. That is, each control is fixed to one part of the room. Such proprietary systems restrict flexibility and are not scalable because it is difficult to add or change rooms after the initial installation of these proprietary solutions. Moreover, these proprietary designs also assume that the house is pre-wired to receive audio/video transmission in the different rooms.

For the reasons state above, and for other reasons stated below that will become apparent to those skilled in the art upon reading and understanding the present specification, there is a need in the art for a scaleable less costly A/V system.

### SUMMARY OF INVENTION

The above-mentioned problems with architectures using traditional A/V systems are addressed by embodiments of the present invention and will be understood by reading and studying the following specification.

In one embodiment, an audio/video control system is disclosed. The system includes, a plurality of audio/video (A/V) devices, an A/V interface panel in communication with the plurality of A/V devices, a switching matrix and an access device. The switching matrix is adapted to selectively control connections between the plurality of A/V devices through the audio/video interface panel. The access device is adapted to receive directions and produce control signals based on the received directions. Moreover, the access device is in communication with the switching matrix to control the switching matrix.

In another embodiment, an audio/video (A/V) control system includes one or more access devices, a controller and one more A/V devices. Each access device includes a GUI that is adapted to describe controls for one or more A/V devices. The access device further has an input to select specific controls described in the GUI. The controller is in communication with the one or more access devices. The controller is further adapted to process signals from the one or more access devices and produce control signals based on the signals from the one or more access devices. In addition, the one or more A/V devices are in communication with the controller. Each A/V device is adapted to be controlled by the control signals from the computer controller.

In still another embodiment, a method for controlling an audio/video (A/V) system using a network interface is disclosed. The method comprises directing a controller using an access device. Generating control signals at the controller based on the directions of the access device. Controlling a switching matrix with at least one of the control signals and switching A/V signals between input and output interfaces with the switching matrix.

In further another embodiment, a method for controlling an audio/video (A/V) system using a network interface is disclosed. The method comprises displaying a graphic user interface (GUI) on an access device in response to a prompt. Providing directions in response to the GUI. Sending the directions to a controller. Processing the directions with the controller and outputting control signals based on the directions and controlling the inputs and outputs of A/V devices based on the control signals.

In still further another embodiment, a method of controlling audio and video (A/V) devices is disclosed. The method comprises executing a software program. Displaying a graphics user interface (GUI). Directing control of a select A/V device via the GUI. Sending control directions to a server program and controlling the select A/V device with the server program.

In yet still another embodiment, a computer readable medium including instructions for controlling one or more audio/video (A/V) devices is disclosed. In one embodiment, the instructions comprise invoking a GUI screen in response to a prompt. Directing control of select A/V devices with use of the GUI screen. Processing control directions with a controller and controlling a switching matrix based on select processed control directions to selectively connect outputs of select A/V devices to inputs of select A/V devices.

Further yet in another embodiment, an audio/video (A/V) control system is disclosed. The system comprises an access device, a controller, a plurality of A/V devices and a switching device. The access device provides a user interface. The controller is in communication with the access to process signals from the access device. The controller further is in communication with the web server. The plurality of A/V devices are adapted to be controlled by the controller. Each A/V device has an input and an output. The switching device is adapted to switchably connect select A/V inputs to select A/V outputs. The switching device is controlled by the controller.

In still further another embodiment, a control mixer/matrix is disclosed. The control mixer includes an input panel, an output panel, an analog mixer/digital matrix, a A/D converter and a controller port. The input panel has a plurality of input ports. Each input port is adapted to be coupled to a select audio/video (A/V) device. The output panel has a plurality of output ports. Each output port is adapted to be coupled to a select A/V device. The analog mixer/digital matrix is adapted to selectively route paths between the input ports and the output ports. The A/D converter is adapted to convert signals between analog and digital. Moreover, the A/D converter is coupled to the analog mixer/digital matrix. The controller port is adapted to be coupled to a controller. The controller port is further in communication with the analog mixer/digital matrix.

In yet another embodiment, a method of operating a network based control mixer/matrix is disclosed. The method comprises communicating directions to a controller through a network regarding the control of an audio/video device. Determining a media type of the audio device. When the media type is digital, processing the directions into control signals and adjusting a mixer/matrix in response to the control signals.

### BRIEF DESCRIPTION OF DRAWINGS

The present invention can be more easily understood and further advantages and uses thereof more readily apparent, when considered in view of the description of the preferred embodiments and the following figures in which:

FIG. 1 is a detailed block diagram of one embodiment of a network based control architecture for A/V systems;

FIG. 2 is an illustration of one embodiment of a network based control architecture for audio systems;

FIG. 3 is an illustration of one embodiment of a network based control architecture for A/V control systems;

FIG. 4 is a flowchart of the method of operation of one embodiment of a network based control architecture for A/V systems;

FIG. 5 is a flow chart of the method of operation of another embodiment of a network based control architecture for A/V systems;

FIG. 6 is an example of a graphical user interface for a network based control architecture for A/V systems of one embodiment of the present invention;

FIG. 7 is a block diagram of an A/V control mixer/matrix of one embodiment of the present invention; and

FIG. 8 is a flow chart of the method of operation of one embodiment of a network based home A/V control system.

In accordance with common practice, the various described features are not drawn to scale but are drawn to emphasize specific features relevant to the present invention. Reference characters denote like elements throughout Figures and text.

### DETAILED DESCRIPTION

In the following detailed description of the preferred embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

The present invention provides relatively cheap, versatile and better scaling A/V control system that can be implemented without using proprietary control circuitry. In embodiments of the present invention only one special piece of hardware (a switching device such as a switching matrix or mixer) is typically needed. The rest of the access points use standard PC (or PDA) interfaces commonly in use today. Moreover, embodiments of the present invention allows for A/V signals to be streamed over local area networks (LAN) or the internet so that they are available remotely.

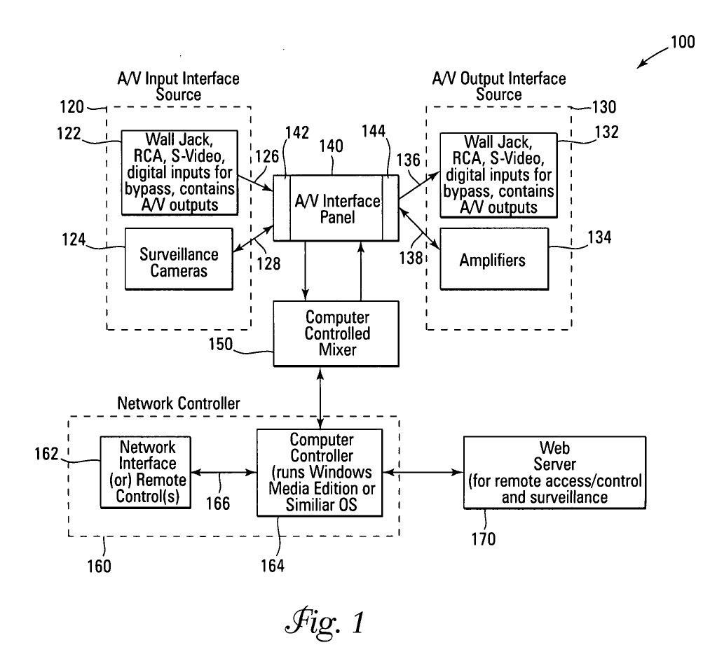

Referring to FIG. 1, a block diagram of a control system 100 with network based control architecture for A/V systems of one embodiment of the present invention is illustrated. As illustrated, system 100 comprises an A/V input interface source 120, A/V output interface source 130, a network controller 170, an A/V interface panel 140 and a computer controlled mixer 150. The input interface source 120 of this embodiment includes wall jacks 122 and surveillance cameras 124 and the output interface source 130 of this embodiment includes wall jacks 132 and amplifiers 134. Wall jacks 122 and 132 are situated in various rooms in a building and are adapted to receive and send signals to and from a variety of audio/video equipment. In one embodiment, the wall jacks are adapted to receive RCA, S-video and digital inputs.

Interface sources 120 and 130 are coupled to an A/V interface panel 140 which is in turn coupled to a computer controlled mixer 150. In one embodiment, the interface panel 140 is at a central location where all the inputs from various rooms are terminated and it provides easy access to the various input signals for fault isolation. The computer controlled mixer 150 is controlled by a network controller 160 that comprises of a network interface 162 (or access device 162), control interface 166 and a computer controller 164. In one embodiment, the computer controller 164 runs an operating system such as Windows Media Edition or the like. In another embodiment, the computer controller 164 (controller 164) uses radio remote control or a web interface control to connect to the matrix 150. The computer controller 164 also may host a wireless access point or router. In one embodiment, the computer controlled mixer 150 provides the function of switching individual inputs to outputs based on instructions from the computer controller 164.

In one embodiment, the access device 162 (e.g., PDA, laptop, desktop, remote control or the like) sends control signals via the control interface 166 to the computer controller 164 to achieve control of mixer 150. The control interface 166 could be either a wireless or a wired connection. In another embodiment, the computer controller 164 is coupled to a web-server 170 that provides remote access, control and surveillance of the A/V system. In one embodiment, the web-server 170 is a personal computer. The web-server 170 executes a web-server application to control A/V devices and sends any audio or video streams from the A/V devices over the internet or LAN to a remote location. In one embodiment, the system 100 uses an Ethernet network for communication between devices.

System 100 further includes A/V input panel 142 and A/V output panel 144. Depending on the specific application, the outputs 136, 138 may be amplified, or left at the program level. Inputs 126 and 128 are in communication with the input panel 142. In one embodiment, inputs 126 and 128 are adapted to be directed to any of the multiple outputs 136, 138 via mixer 150. In one embodiment, the mixer 150 is a digitally controlled switching matrix 150. Further, in one embodiment, analog inputs within 142 are first routed through a digital hardware within switching matrix 150. In one embodiment, switching matrix 150 includes filters. In another embodiment, the analog signals are converted to a digital format at the interface 142. In one embodiment, streaming digital A/V may be added to the mix from a PC based user-interface connected to wall jacks 122. After all the digital filtering is completed, the signal is “mixed” to appropriate independent output channels 138, 136 and received at the amplifiers 134.

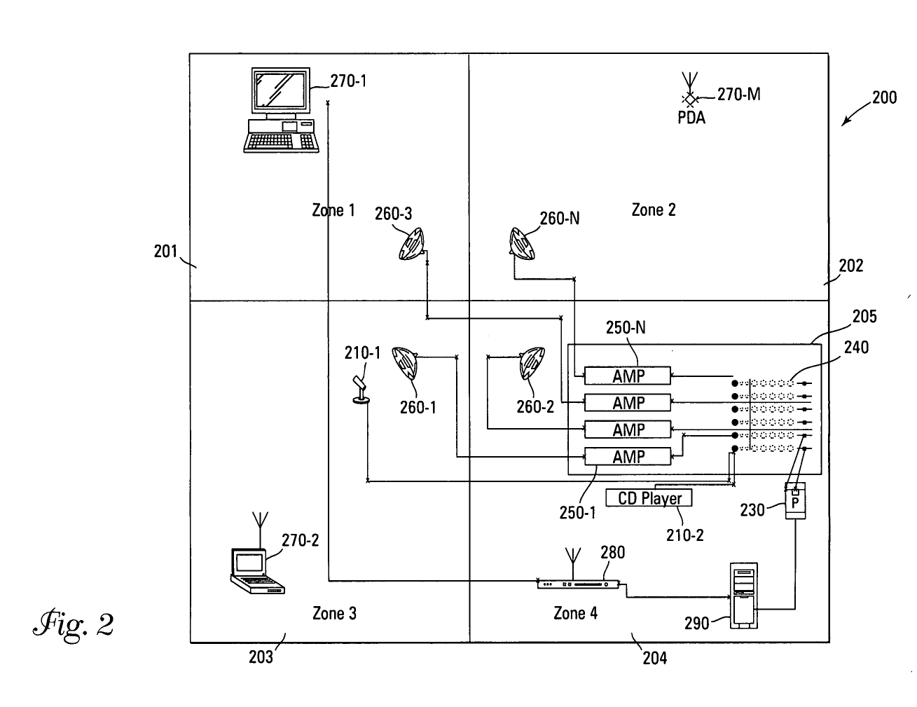

FIG. 2 is an illustration of a network based control architecture for audio/video systems, indicated generally at 200, of another embodiment of the present invention. The building in this example is divided into zone-1 201, zone-2 202, zone-3 203 and zone-4 204 to indicate separate rooms. System 200 comprises an audio system 205 available at zone-4 203. The audio system 205 includes mixer 240 and amplifiers 250-1 through 250-N. Additionally, system 200 comprises a computer controller 290 (controller 290) which is coupled to the mixer 240 through a microprocessor interface 230. The computer controller 290 directs the mixer 240 to switch particular input channels to output channels based on commands received from any of the access devices 270-1 through 270-M. Access devices 270-1 through 270-M illustrated in this embodiment, include a desktop computer 270-1, a laptop 270-2 and a personal data assistant (PDA) 270-M. Other similar access devices can be used. The access devices 270-1 through 270-M are used to direct the computer controller 290 via a switch/router 280. In this embodiment, A/V devices, microphone 210-1 and a CD player 210-2, are connected to a Pre-Amp section 220 of the audio system. Signals from the microphone 210-1 and the CD player 210-210-2 are received by the switching matrix 240 and amplifiers 250-1 through 250-N. The amplifiers 250-1 to 250-N are connected to speakers 260-1 to 260-N. In one embodiment, the switching matrix 240 is a mixer 240. In particular in one embodiment, an analog audio mixer 240 is used that is controlled digitally by the controller 290. Analog audio mixer 240 is adapted to provide outputs to select A/V devices. In this embodiment, microprocessor interface 230 is adapted to interface control signals between the controller and the analog audio mixer 240. Moreover, in this embodiment, the interface 230 sends different voltages to pots on the mixer 240 to control outputs. These outputs are amplified and sent to speakers in various parts of the home.

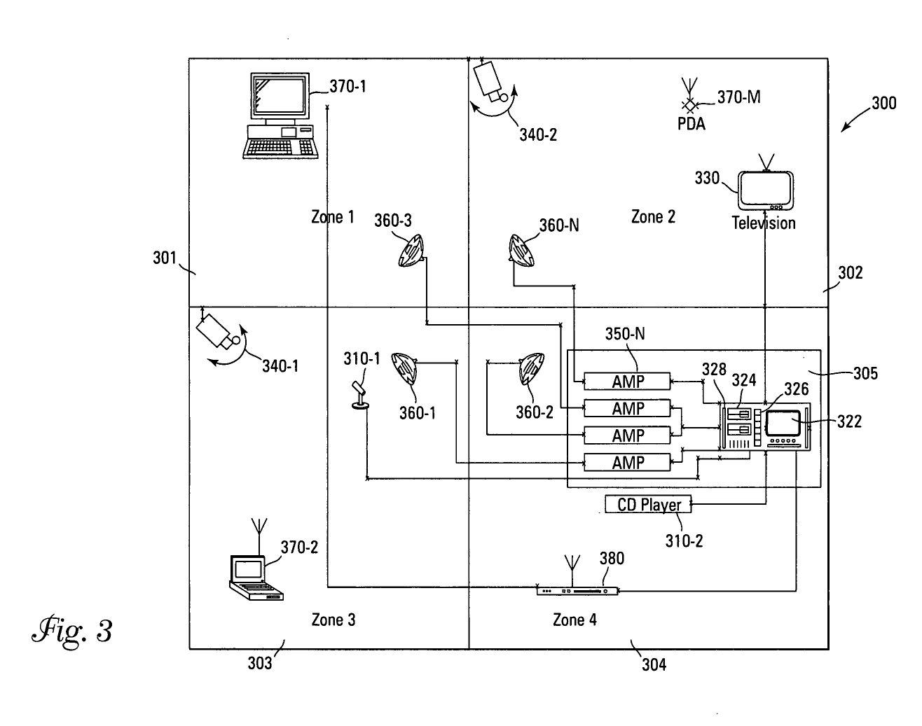

FIG. 3 is an illustration of another embodiment of an A/V control system 300 of the present invention. The building of FIG. 3 is divided into four zones zone-1 301, zone-2 302, zone-3 303 and zone-4 304 indicating separate rooms. System 300 at zone-4 comprises an integrated A/V system 305 that includes amplifiers 350-1 through 350-N that are connected to A/V devices, speakers 360-1 through 360-N. Also included in the integrated A/V system 305 is computer controller 322, network control server 324, switch matrix or mixer 326 and A/V interface panel 328. The computer controller may generally be referred to as a “controller 322”. Additionally, system 300 comprises A/V devices that include video cameras 340-1 and 340-2 and a television 330. Access devices 370-1 through 370-M direct the computer controller 322 via a switch router 380. Specifically, system 300 comprises access devices such as a personal computer 370-1, laptop 370-2 and personal data assistant (PDA) 370-M. A standard web browser initiated in any of the access devices 370-1 through 370-M establishes a connection to the switch matrix 326 or mixer 326. Upon establishing connectivity with the switch matrix 326 or mixer 326, commands are sent from the access device to achieve proper switching of audio/video channels thereby making it available at the desired zones.

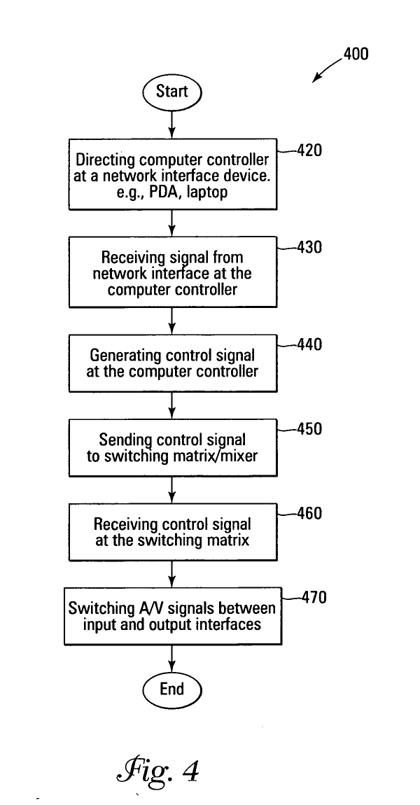

FIG. 4 is a flowchart 400 of a method of operation of one embodiment of the present invention. An access device such as a desktop computer, laptop or a PDA directs a computer controller using a software program to perform the function of switching select A/V signals from select ports to certain other ports (420). This includes directing the A/V system to provide audio or video connectivity to a particular room. In one embodiment, the software program resides in the access device. In yet another embodiment, the software program resides remotely on a file server or a storage device. In block 430 the computer controller receives an appropriate signal from an access device and generates a control signal in block 440.

The generated control signal is then sent to the switching matrix/mixer (450). The control signal is then received at the switching matrix/mixer (460). The switching matrix/mixer then performs the operations defined by the control signals (270). Such operations include passing on control signals to select A/V devices and routing A/V device signals between select input and output interface sources. Examples of desired controls generated at the access device include control of volume, channel, brightness, contrast, tilt of a camera and a change in the zoom of a camera.

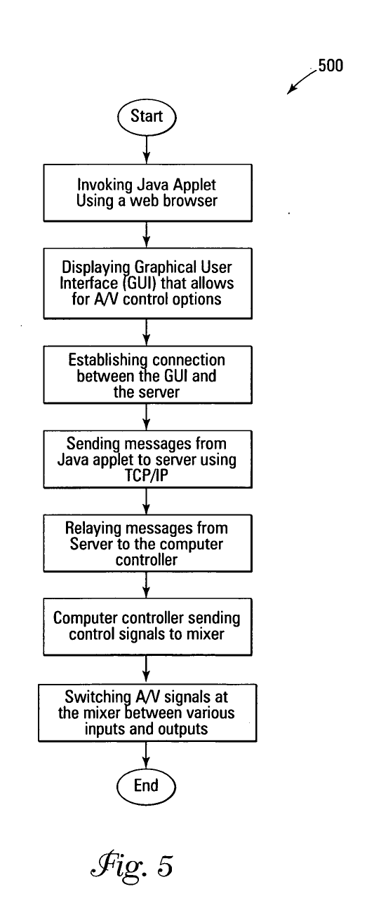

FIG. 5 is a flowchart 500 of a method of operation of another embodiment of the present invention. A user invokes a software program using a web server (520). Software programs such as scripting software (e.g., Java) maybe used. In one embodiment, the software program may be present either in the network interface device (access device) or available remotely on a server or a storage device. In one embodiment, internet technologies such as virtual private network (VPN) or tunneling may be used to establish a connection with the server. Following the invoking of the software (520), a graphical user interface (GUI) is displayed (530). The graphical user interface enables the user to control A/V devices. Such control includes directing particular input A/V signals to various locations within the building. In one embodiment, the user has a broad range of control with respect to the various parameters of the audio/video signals such as volume, channel, color, brightness . . . etc.

A connection is then established between the GUI and the server (530). In one embodiment, the protocol used for the connection between the network interface device and the server is TCP/IP. In particular in this embodiment, messages are sent from a Java Applet to the server using TCP/IP (550). Subsequently, these messages are relayed from the server to a computer controller (560). In one embodiment, the computer controller and the server are in the same device. The computer controller sends control signals to the mixer based on the messages received from the server (570). The computer controller translates the messages relayed from the server into control signals that directs the switching matrix to perform the appropriate switching. Finally, the mixer upon receiving the control signal from the computer controller forwards requested A/V signals from various inputs to appropriate outputs of the mixer (580). In embodiments of the present invention, the control signal sends commands to the switching matrix. In response to the control signals, the matrix provides select paths to and from associated A/V devices. In one embodiment, the control signal allows the switching matrix to provide A/V signals to a web server that is connected to the internet which allows remote access to the A/V devices.

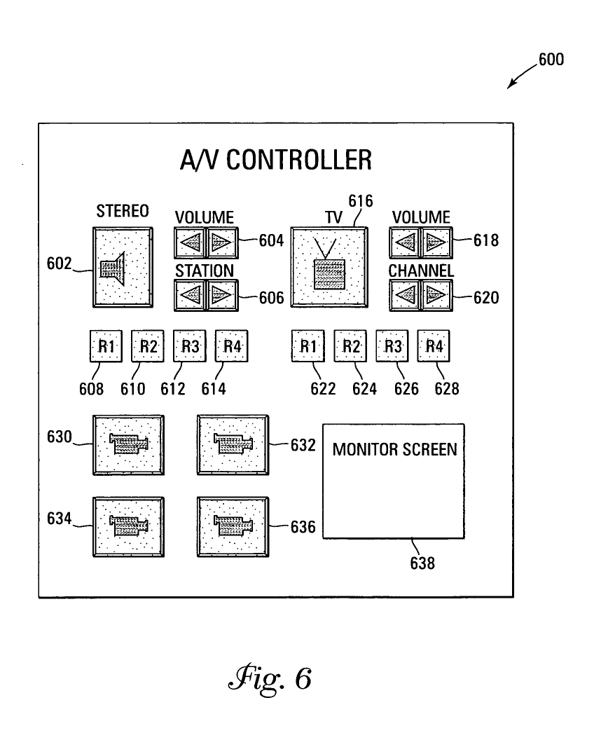

FIG. 6 is an illustration of an example of a graphical user interface (GUI) of an access device, indicated generally at 600 of one embodiment of the present invention. GUI 600 of the access device includes control for an audio device (a stereo in this example), a video device (a TV in this example) as well as controls for cameras R1-R4 630, 632, 634 and 636. In controlling the stereo in this example of the GUI, the stereo button 602 is first activated. The volume and station of the stereo can then be controlled by selectively activating the volume and stations buttons 604 and 606. Moreover, the room in which you want control functions (i.e. station and volume) of the stereo is selected by the room select button 608, 610, 612 and 614. For example, if you wanted to turn the volume up in speakers in room R3, you would activate the stereo button 602, room R3 button 612 and the increase in volume button 604. The TV in this embodiment is also controlled in a similar manner. The TV is controlled by first activating the TV button 616. The volume and channel are then controlled by activation of the volume and channel buttons 618 and 620. The room in which control of the TV is to occur is controlled by the room buttons 622, 624, 626 and 628. Moreover, video cameras in rooms R1, R2, R3 and R4 are controlled by camera buttons 630, 632, 634 and 636. This embodiment of a GUI of an access device also has a monitor screen 638 to view video images (i.e. for example from the video cameras). The monitor screen 638 in other embodiments further provide conformation of entered commands as well as other control parameters that can be implemented by the access device. As discussed above, the access device is in communication with the controller and the controller is adapted to control a control mixer/matrix to selectively route the control signals to select devices and signals from select A/V device to other select A/V devices. For example, signals from one channel of a stereo in a first room can be routed to a first speaker in a second room and signals from a second channel from the stereo in the first room can be routed to a second speaker in the second room to achieve stereo sound in the second room.

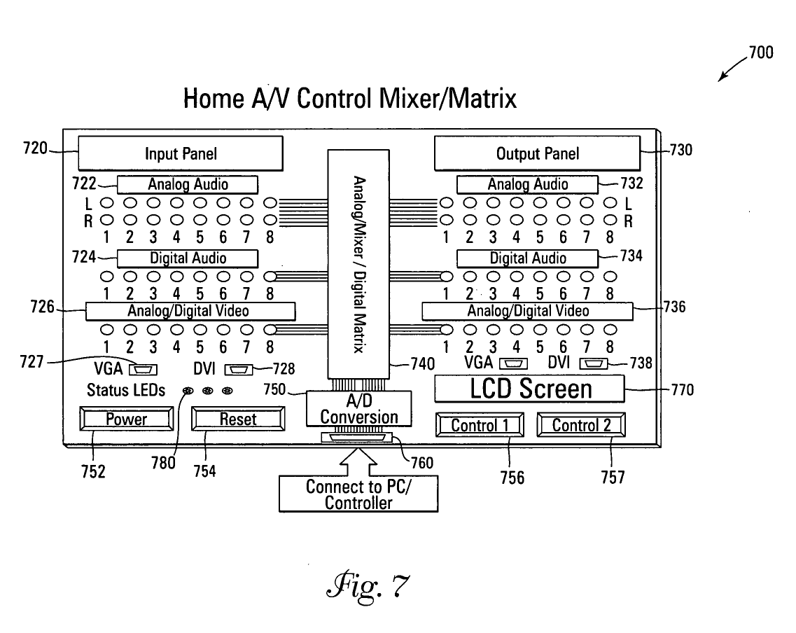

FIG. 7 is a block diagram of an A/V control mixer/matrix 700 of one embodiment of the present invention. As illustrated, A/V control matrix/mixer 700 includes an input panel 720 and an output panel 730. The input panel 720 includes analog audio ports 722, digital audio ports 724, analog/digital video ports 726, an video graphics array (VGA) port 727 and a digital video input (DVI) port 728. Output panel 730 includes analog audio ports 732, digital audio ports 734, analog/digital video ports 736, a VGA port 737 and a DVI port 738. Each of the ports 722, 724, 726, 727, 728, 732, 734, 736, 737 and 738 are adapted to be coupled to an associated A/V device.

Also included in the A/V control mixer/matrix 700 is an analog mixer/digital matrix 740. The control mixer/matrix 700 is adapted to selectively couple select inputs ports 722, 724, 726, 727 and 728 with select output ports 732, 734, 736, 737 and 738. An analog to digital (A/D) converter 750 is coupled to the mixer 740 to convert signals between analog and digital. Also shown is control port 760. Control port 760 provides a communication link between a controller and the mixer/matrix 740 wherein the controller can control the mixer/matrix 740. Also included in this embodiment of the present invention is a power and reset controls 752 and 754 and status LEDs 780. Further included in this embodiment, is a display screen 770 adapted to display information provided by the mixer. The information is invoked by control buttons 756 and 757. Such information may include information regarding volume, channel selection, routing information and the like. In one embodiment, controls 756 and 757 allow for the control of at least some of the functions of the control mixer/matrix 700.

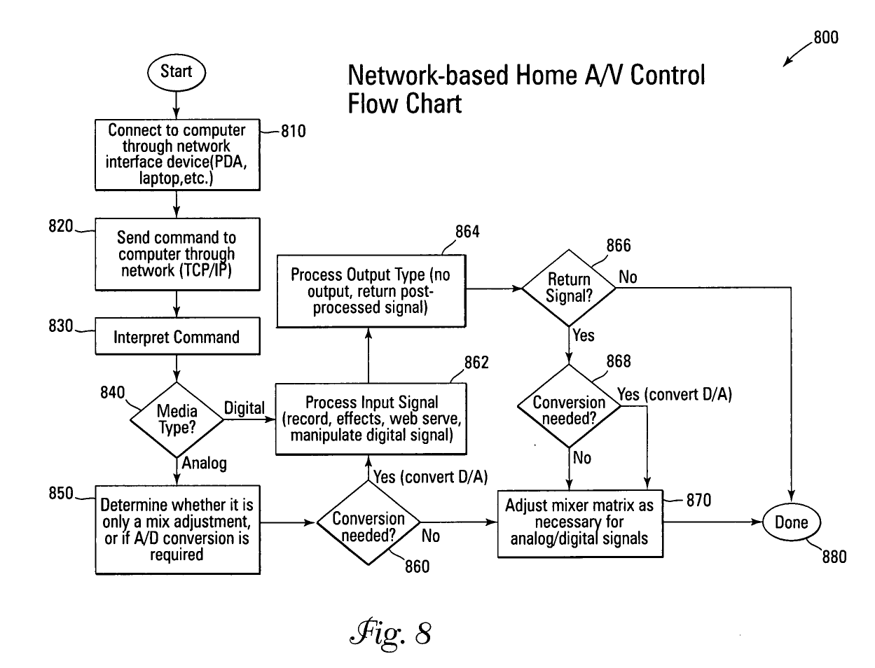

FIG. 8 is a flowchart 800 of a method of operation of another embodiment of the present invention. This process starts when a network interface device or access device (e.g., PDA, laptop) connects to a computer controller (810). Commands are then sent to a computer controller by the access device using TCP/IP (820). The commands are then interpreted by the controller (830). It is then determined whether the media type associated with the command is digital or analog (840).

If the media type is digital (840), an input signal is processed (862). The output type is then processed (864). It is then determined if there will be a return signal (866). If there is no return signal required (866), the process is done (880). If it is determined that a return signal is required (866), it is then determined if a conversion needs to take place (868). If a conversion needs to take place (868), a D/A conversion is performed and the mixer/matrix directed to perform its switching functions (870). If no conversion is needed (868), the mixer/matrix directed to perform its switching functions (870). The process then ends one the mixer/matrix has completed its task (880).

If the media type is analog (850), it is determined if a conversion need to take place (860). If no conversion is needed (860), the mixer/matrix directed to perform its switching functions (870). If a conversion is needed (860) an A/D conversion is performed and an input signal is processed (862). The output type is then processed (864). It is then determined if there will be a return signal (866). If there is no return signal required (866), the process is done (880). If it is determined that a return signal is required (866), it is then determined if a conversion needs to take place (868). If a conversion needs to take place (868), a D/A conversion is performed and the mixer/matrix is directed to perform its switching functions (870). If no conversion is needed (868), the mixer/matrix directed to perform its switching functions (870). The process then ends once the mixer/matrix has completed its tasks (880).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. An audio/video control system, the system comprising:
a plurality of audio/video (A/V) devices;
an A/V interface panel in communication with the plurality of A/V devices;
a switching matrix adapted to selectively control connections between the plurality of A/V devices through the audio/video interface panel; and
an access device adapted to receive directions and produce control signals based on the received directions, the access device in communication with the switching matrix to control the switching matrix.

2. The system of claim 1, further comprising:
a controller coupled between the switching matrix and the access device, the controller adapted to process the control signals and control the switching matrix.

3. The system of claim 1, wherein the audio/video devices comprises at least one of a CD player, a surveillance camera, a speaker, a microphone and an amplifier.

4. The system of claim 1, wherein the access device includes a web browser and is connected to a web server to allow remote location control of the A/V devices.

5. The system of claim 1, wherein the access device has a graphic user interface adapted to solicit the directions.

6. The system of claim 1, wherein the switching matrix is a mixer.

7. The system of claim 1, where in the switching matrix includes a converter that converts the audio/video signals between analog and digital.

8. The system of claim 1, wherein the A/V interface panel includes a converter that converts the A/V signals between analog and digital.

9. The system of claim 1, further comprising;
amplifiers that amplify the A/V signals sent and received by the audio/video interface panel.

10. The system of claim 1, further comprising:
a controller adapted to control the switching matrix based on the control signals from the access device, the controller further adapted to control the A/V devices.

11. The system of claim 1, wherein the switching matrix is an analog audio mixer that is adapted to be controlled digitally by a controller.

12. A audio/video (A/V) control system, the system comprising:
one or more access devices, each access device having a GUI adapted to describe controls for one or more A/V devices, the access device further having an input to select specific controls described in the GUI;
a controller in communication with the one or more access devices, the controller adapted to process signals from the one or more access devices and produce control signals based on the signals from the one or more access devices; and
one or more A/V devices in communication with the controller, each A/V device adapted to be controlled by the control signals from the computer controller.

13. The system of claim 12, further comprising:
a router adapted to route signals from the one of more access devices to the controller.

14. The system of claim 12, wherein the A/V devices comprises at least one of a stereo, a CD player, a microphone, a video camera, a television and speakers.

15. The system of claim 12, wherein the one or more access devices comprises at least one of a computer, a phone with web access and personal digital assistant (PDA).

16. The system of claim 12, further comprising:
a switching matrix controlled by the controller, the switching matrix adapted to selectively route control signals to select A/V devices and provide select signal paths between select A/V devices.

17. The system of claim 16, further comprising:
one or more amplifiers adapted to selectively amplify A/V signals routed between select A/V devices.

18. The system of claim 16, wherein at least one of the one or more devices is an-analog device, the system further comprising:
at least one analog to digital (A/D) converter to convert analog signals from the at least one analog A/V device; and
at least one digital to analog converter (D/A) to convert digital signals from the system to analog signals for the at least one analog A/V device.

19. The system of claim 18, further comprising:
at least one filter adapted to filter signals from the at least one A/D converter.

20. The system of claim 12, further comprising:
an analog audio mixer adapted to be controlled digitally by the controller, the mixer adapted to provide outputs to select A/V devices.

21. The system of claim 20, further comprising:
a microprocessor interface adapted to interface control signals between the controller and the analog audio mixer.

22. A method for controlling an audio/video (A/V) system using a network interface, said method comprising:
directing a controller using an access device;
generating control signals at the controller based on the directions of the access device;
controlling a switching matrix with at least one of the control signals; and
switching A/V signals between input and output interfaces with the switching matrix.

23. The method in claim 22, further comprising:
communicating wirelessly between the access device and the controller.

24. The method in claim 22, further comprising:
controlling an A/V device with at least one of the control signals.

25. The method of claim 22, further comprising:
using a switched router to communicate between the access device and the controller.

26. The method in claim 22, wherein the access device is one of an audio/video device selected from a group comprising, a Personal Data Assistant, a cell phone and a laptop.

27. The method in claim 22, wherein the switching matrix is a mixer.

28. The method in claim 22, further comprising;
providing access to the internet to allow control of and the passing of A/V signals to and from remote locations.

29. A method for controlling an audio/video (A/V) system using a network interface, said method comprising:
displaying a graphic user interface (GUI) on an access device in response to a prompt;
providing directions in response to the GUI;
sending the directions to a controller;
processing the directions with the controller and outputting control signals based on the directions; and
controlling the inputs and outputs of A/V devices based on the control signals.

30. The method of claim 29, wherein controlling the inputs and outputs of A/V devices further comprises:
directing a switch matrix to selectively couple inputs and outputs of select A/V devices.

31. The method of claim 29, wherein controlling the inputs and outputs of A/V devices further comprises:
controlling an analog audio mixer digitally via an interface to selectively couple inputs and outputs of select A/V devices.

32. The method in claim 29, further comprising:
using a transmission control protocol/internet protocol (TCP/IP) interface between the access device and the controller.

33. The method of claim 29, further comprising:
coupling the access device and the controller to the internet to provide remote access.

34. A method of controlling audio and video (A/V) devices, the method comprising:
executing a software program;
displaying a graphics user interface (GUI);
directing control of a select A/V device via the GUI;
sending control directions to a server program; and
controlling the select A/V device with the server program.

35. The method of claim 34, wherein directing control of the select A/V device further comprises:
activating select controls illustrated in the (GUI).

36. The method of claim 34, wherein the software program is a web browser.

37. The method of claim 36, wherein the web browser invokes Java Applets.

38. The method of claim 34, wherein sending control directions to a server program further comprises:
sending TCP/IP control messages to the server program.

39. The method of claim 34, wherein controlling the select A/V device with the server program further comprises:
sending directions serially to the A/V device.

40. The method of claim 34, wherein controlling the select A/V device with the server program further comprises:
controlling a switch matrix.

41. A computer readable medium including instructions for controlling one or more audio/video (A/V) devices, the method for controlling said one or more A/V devices comprising:
invoking a GUI screen in response to a prompt;
directing control of select A/V devices with use of the GUI screen;
processing control directions with a controller; and
controlling a switching matrix based on select processed control directions to selectively connect outputs of select A/V devices to inputs of select A/V devices.

42. The method of claim 41 further comprising:
controlling one or more A/V with the controller based on select processed control directions;

43. The method of claim 42, further comprising receiving A/V signals from one or more A/V devices at the GUI screen.

44. The method of claim 41, further comprising:
communicating control signals from a web browser to the controller using TCP/IP.

45. A audio/video (A/V) control system, the system comprising;
an access device to provide a user interface;
a controller in communication with the access to process signals from the access device, the controller further in communication with a web server;
a plurality of A/V devices adapted to be controlled by the controller, each A/V device having an A/V input and an A/V output; and
a switching device adapted to switchably connect select A/V input to select A/V outputs, the switching device controlled by the controller.

46. The system of claim 45, wherein the switching device is a switching matrix.

47. The system of claim 45, wherein the switching device is an analog audio mixer adapted to be controlled digitally.

48. The system of claim 45, wherein the controller is adapted to stream A/V signals from the A/V devices over a local access network.

49. The system of claim 45, wherein the controller is adapted to stream A/V signals from the A/V devices over the internet.

50. A control mixer/matrix comprising:
an input panel having a plurality of input ports, each input port adapted to be coupled to a select audio/video (A/V) device;
an output panel having a plurality of output ports, each output port adapted to be coupled to a select A/V device;
an analog mixer/digital matrix adapted to selectively route paths between the input ports and the output ports;
a A/D converter adapted to convert signals between analog and digital, the A/D converter coupled to the analog mixer/digital matrix; and
a controller port adapted to be coupled to a controller, the controller port further in communication with the analog mixer/digital matrix.

51. The control mixer/matrix of claim 50, further comprising:
a display adapted to convey information regarding the control mixer/matrix; and
at least one control button adapted control the information in the display.

52. The control mixer/matrix of claim 50, wherein the at least one control button is further adapted to control at least some of the functions of the control mixer/matrix.

53. A method of operating a network based control mixer/matrix, the method comprising:
communicating directions to a controller through a network regarding the control of an audio/video device;
determining a media type of the audio device;
when the media type is digital, processing the directions into control signals; and
adjusting a mixer/matrix in response to the control signals.

54. The method of claim 53, further comprising:
when the media type is analog, determining whether the directions only require a routing by the mixer/matrix or whether a A/D conversion is needed.

55. The method of claim 54, further comprising:
when an A/D conversion is required, routing a desired signal through a converter.

56. The method of claim 53, further comprising:
determining if a return signal is required.

57. The method of claim 56, further comprising:
when a return signal is required, determining if a D/A conversion is required.

58. The method of claim 57, further comprising:
when a D/A conversion is required, routing the desired signal to be converted through a converter.

59. The method of claim 54, further comprising:
processing an input signal; and
processing an output type.
